(19) United States
(12) Patent Application Publication
(10) Pub. No.: US 2023/0111782 A1
(43) Pub. Date: Apr. 13, 2023

(54) REQUEST PROCESSING METHOD BASED ON CONSORTIUM BLOCKCHAIN, DEVICE, AND STORAGE MEDIUM

(71) Applicant: Beijing Baidu Netcom Science Technology Co., Ltd., Beijing (CN)

(72) Inventor: Tong JIN, Beijing (CN)

(21) Appl. No.: 17/964,177

(22) Filed: Oct. 12, 2022

(30) Foreign Application Priority Data
Oct. 13, 2021 (CN) 202111189947.8

(51) Int. Cl. H04L 9/32; H04L 9/00

(52) U.S. Cl. CPC H04L 9/32; H04L 9/50

(57) ABSTRACT

Request processing method based on a consortium blockchain, a device, and a storage medium. The implementation solution is: receiving a transaction processing request from a first party authority proxy service of a first party blockchain node through a second party authority proxy service of a second party blockchain node; performing authority verification on the transaction processing request; and in a case where the authority verification passes, sending the transaction processing request to the second party blockchain node to make the second party blockchain node process the transaction processing request. Therefore, the flexibility and convenience of request processing can be improved.

### CROSS-REFERENCE TO RELATED APPLICATION

This application claims the priority to Chinese Patent Application No. CN202111189947.8 filed on Oct. 13, 2021, the disclosure of which is incorporated herein by reference in its entirety.

### TECHNICAL FIELD

The present disclosure relates to the field of computer technologies, in particular to the field of blockchain technologies, may be used for cloud computing and cloud service, and specifically, relates to a request processing method and apparatus based on consortium blockchain, a device, and a storage medium.

### BACKGROUND

The consortium blockchain is a manifestation of the blockchain system, which is different from the public chain. The consortium blockchain only allows authorized nodes to join a network and may assign several organizations or institutions to participate in the management of the blockchain, and each participant may run one or more nodes. The participants may have a blockchain and store their own data on the blockchain.

The consortium blockchain network may give different authority control to each blockchain for different participants to access. Therefore, how to control the access of the consortium blockchain network is very important.

### SUMMARY

The present disclosure provides a request processing method and apparatus based on a consortium blockchain, a device, and a storage medium

According to an aspect of the present disclosure, a request processing method based on a consortium blockchain is provided. The method includes the steps described below.

A transaction processing request is received from a first party authority proxy service of a first party blockchain node through a second party authority proxy service of a second party blockchain node.

Authority verification is performed on the transaction processing request.

In a case where the authority verification passes, the transaction processing request is sent to and is processed by the second party blockchain node.

According to another aspect of the present disclosure, an electronic device is provided.

The electronic device includes at least one processor and a memory which is in a communication connection with the at least one processor.

The memory stores an instruction executable by the at least one processor, and the instruction, when executed by the at least one processor, enables the at least one processor to perform the request processing method based on a consortium blockchain provided by any of embodiments of the present disclosure.

According to another aspect of the present disclosure, a non-transitory computer-readable storage medium storing a computer instruction is provided, where the computer instruction is used for enabling a computer to perform the request processing method based on a consortium blockchain provided by any of embodiments of the present disclosure.

According to the technology of the present disclosure, the flexibility and convenience of request processing in the consortium blockchain network can be improved.

It is to be understood that the content described herein is not intended to identify key or important features of embodiments of the present disclosure nor is it intended to limit the scope of the present disclosure. Other features of the present disclosure will be readily understood through the following description.

### BRIEF DESCRIPTION OF THE DRAWINGS

The drawings are for a better understanding of the present disclosure and do not constitute a limitation of the present disclosure. In the drawings:

FIG. 1A is a schematic diagram of a request processing method based on a consortium blockchain according to an embodiment of the present disclosure;

FIG. 1B is a schematic diagram of a consortium blockchain network according to an embodiment of the present disclosure;

FIG. 1C is a schematic diagram of another consortium blockchain network according to an embodiment of the present disclosure;

FIG. 2A is a schematic diagram of another request processing method based on a consortium blockchain according to an embodiment of the present disclosure;

FIG. 2B is a schematic diagram of a data format of authority data according to an embodiment of the present disclosure;

FIG. 3 is a schematic diagram of another request processing method based on a consortium blockchain according to an embodiment of the present disclosure;

FIG. 4 is a schematic diagram of another request processing apparatus based on a consortium blockchain according to an embodiment of the present disclosure; and

FIG. 5 is a block diagram of an electronic device for implementing a request processing method based on a consortium blockchain according to an embodiment of the present disclosure.

### DETAILED DESCRIPTION

Example embodiments of the present disclosure are described below in conjunction with the drawings, including various details of the embodiments of the present disclosure for the purpose of understanding, and should be considered exemplary only. Accordingly, those of ordinary skill in the art will appreciate that various changes and modifications may be made to the embodiments described herein without departing from the scope and spirit of the present disclosure. For the sake of clarity and conciseness, the description of well-known functions and structures is omitted in the following description.

The solutions provided by the present disclosure will be described in detail below in conjunction with drawings.

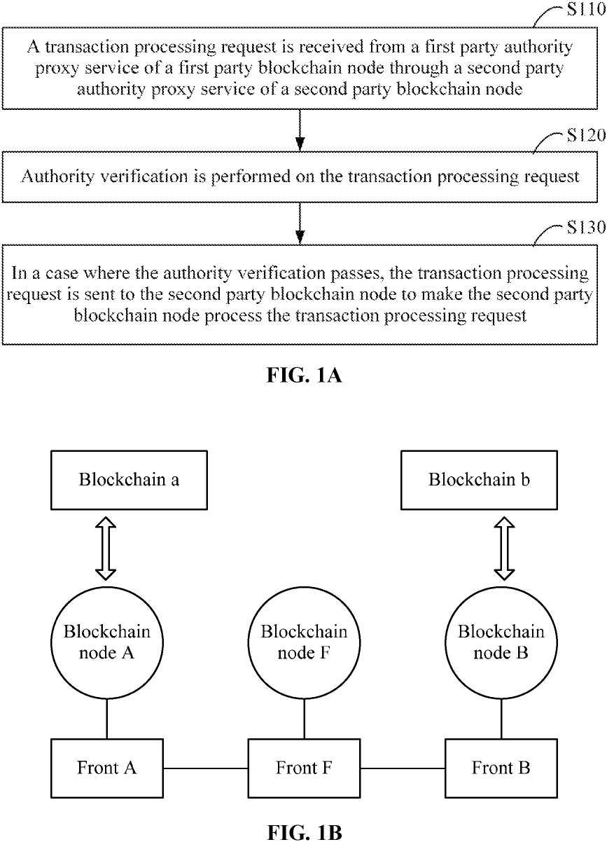

FIG. 1A is a schematic diagram of a request processing method based on a consortium blockchain according to an embodiment of the present disclosure. This embodiment of the present disclosure is suitable for the case where authority control is performed on a transaction processing request of a blockchain of the consortium blockchain network. The method may be executed by a request processing apparatus based on a consortium blockchain, and the apparatus may be implemented by hardware and/or software and may be configured in an electronic device. With reference to FIG. 1A, the method specifically includes steps S110, S120, and S130.

In S110, a transaction processing request is received from a first party authority proxy service of a first party blockchain node through a second party authority proxy service of a second party blockchain node.

In S120, authority verification is performed on the transaction processing request.

In S130, in a case where the authority verification passes, the transaction processing request is sent to the second party blockchain node to make the second party blockchain node process the transaction processing request.

The consortium blockchain network may include at least two participants, and one of the participants represents an organization, an institution or an individual. One participant may manage at least one blockchain node. Some of the at least one blockchain node may be taken as block production nodes configured to participate in the consensus of a blockchain, and if one blockchain node is a block production node of one blockchain, the blockchain node is associated with the blockchain. Some of the at least one blockchain node may only be taken as synchronization nodes, also called as block chasing nodes, configured to not participate in consensus. Blockchains which are independent of each other and does not affect each other in the consortium blockchain may be called parallel chains, that is, the parallel chain is a kind of blockchains and has all the attributes of the general blockchain.

FIG. 1B is a schematic diagram of a consortium blockchain network according to an embodiment of the present disclosure. With reference to FIG. 1B, the blockchain network may include a blockchain node A, a blockchain node B and a blockchain node F, the blockchain node A and the blockchain node B participate in the consensus and are the block production nodes of the blockchain A and the blockchain B, respectively, and the blockchain node F is a synchronization node. That is, the consortium blockchain network includes the blockchain a and the blockchain b, the blockchain a is associated with the blockchain node A, and the blockchain b is associated with the blockchain node B. Each blockchain node in the blockchain network has its own account information, that is, each blockchain node has its own blockchain account public key, blockchain account private key and blockchain account address. The account information may be provided by a certificate authority (CA) service, and the CA service is also responsible for the initial networking of the consortium blockchain network and network transport layer security (TLS) communication. It is to be noted that FIG. 1B is only an example, does not specify the number of blockchain nodes in the consortium blockchain network and the identities of these blockchain nodes, and also does specify the number of blockchains, that is, the consortium blockchain may also have other organizational forms.

In the consortium blockchain network, an authority proxy service Front is also deployed in front of each blockchain node, and authority proxy services of different blockchain nodes are different. With reference to FIG. 1B, the blockchain node A, the blockchain node B and the blockchain node F are deployed with authority proxy service FrontA, authority proxy service FrontB and authority proxy service FrontF, respectively. The authority proxy service is used for filtering, forwarding and processing network messages. Each blockchain node may only communicate with its own authority proxy service, and the direct communication between different blockchain nodes is prohibited. The authority proxy service, as the proxy of a locally connected blockchain node, forwards and broadcasts legal messages and shields and filters illegal messages.

The authority proxy service is deployed for the blockchain node so that the authority control service and the blockchain service in the consortium blockchain network are decoupled, and the authority control service may be plugged and unplugged flexibly and directly construct the consortium blockchain network using the code base of the blockchain service in without the need to transform and develop the network messages of the blockchain service. Access control is performed on the blockchain node through an external authority proxy service so that the authority proxy service may be independent of the blockchain service, and the authority proxy service runs in a process different the process on which the blockchain service runs and may be flexibly loaded into a started blockchain system. Compared with the related art where the authority control is embedded inside the blockchain system code, the preceding arrangement avoids the boundary between the public chain and the consortium blockchain, lowers the construction threshold of the consortium blockchain network, and reduces the construction workload of the consortium blockchain network, thereby improving the construction efficiency of the consortium blockchain network.

The first party blockchain node is the sender of the transaction request, the second party blockchain node is the receiver of the transaction request, the first party blockchain node is configured with the first party authority proxy service, and the second party blockchain node is configured with the second party authority proxy service. This embodiment of the present disclosure does not specifically limit the transaction request type, the identity of the first party blockchain node and the identity of the second party blockchain node, and the first party blockchain node and the second party blockchain node may belong to any blockchain node in the consortium blockchain network.

Specifically, a first party blockchain node initiates a transaction processing request, the first party blockchain node sends the transaction processing request to a first party authority proxy service, the first party authority proxy service sends the transaction processing request to a second party authority proxy service, and the second party authority proxy service performs authority verification on the transaction processing request. If the authority verification passes, the second party authority proxy service sends the transaction processing request to the second party blockchain node, and the second party blockchain node processes the transaction processing request. If the authority verification fails, the second party authority proxy service shields the transaction processing request, that is, the second party authority proxy service refuses to forward the transaction processing request to the second party blockchain node. Illegal messages identified through authority verification are shielded, that is, access requests of malicious blockchain nodes are filtered through the authority proxy service so that blockchain data leakage caused by malicious blockchain nodes can be avoided, thereby improving the security of blockchain data.

In an optional embodiment, a consortium blockchain network to which the second party blockchain node and the first party blockchain node belong further includes an authority control blockchain for recording authority control data of a blockchain in the consortium blockchain network.

FIG. 1C is a schematic diagram of another consortium blockchain network according to an embodiment of the present disclosure. With reference to FIG. 1C, the consortium blockchain network may also include an authority control blockchain. The authority control blockchain, also called a main chain, is used for recording authority control data of each parallel chain in the consortium blockchain network, that is, each parallel chain submits its own authority control data to the authority control blockchain. The authority control blockchain is an open chain that may be accessed by all participants. For example, all participants may monitor the authority control blockchain, access their own authority data or determine whether their own authority data is updated.

Specifically, the second party authority proxy service may acquire the authority control data of a blockchain in the consortium blockchain network from the authority control blockchain and perform authority verification on the transaction processing request using the authority control data. The authority control data of each blockchain is recorded using the authority control blockchain so that the reliability of authority control data and authority verification can be guaranteed.

According to the technical solution provided by this embodiment of the present disclosure, the authority proxy service is deployed for each blockchain node in the consortium blockchain network, and the blockchain nodes only directly communicate with their own authority proxy services and do not communicate with other blockchain service nodes and perform authority verification on the transaction processing request through their own authority proxy services, thereby improving the flexibility and convenience of request processing.

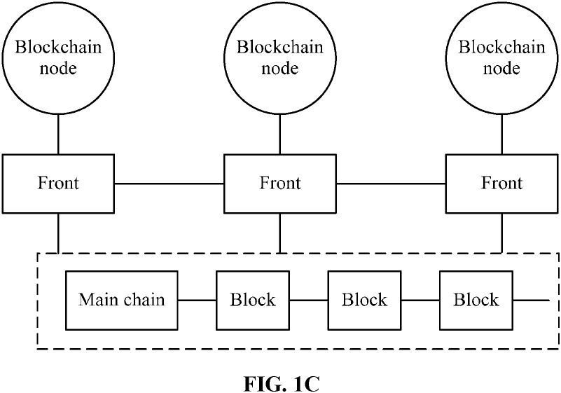

FIG. 2A is a schematic diagram of another request processing method based on a consortium blockchain according to an embodiment of the present disclosure. This embodiment is an optional solution provided on the basis of the above embodiments. With reference to FIG. 2A, the request processing method based on a consortium blockchain provided by this embodiment includes steps S210, S220, S230, S240, S250, and S260.

In S210, an authority update request initiated by a second party blockchain node is acquired through a second party authority proxy service; where the authority update request includes a target blockchain and authority update data of the target blockchain.

In S220, it is determined that whether the second party blockchain node has a write authority on the target blockchain.

In S230, in a case where the second party blockchain node has the write authority on the target blockchain, the authority update data of the target blockchain is controlled to be written into the authority control blockchain.

In S240, a transaction processing request is received from a first party authority proxy service of a first party blockchain node through the second party authority proxy service.

In S250, authority verification is performed on the transaction processing request.

In S260, in a case where the authority verification passes, the transaction processing request is sent to the second party blockchain node to make the second party blockchain node process the transaction processing request.

A consortium blockchain network to which the second party blockchain node and the first party blockchain node belong further includes an authority control blockchain for recording authority control data of a blockchain in the consortium blockchain network.

The authority control data of the blockchain may include a chain identifier of the blockchain, a write node identity of a blockchain node, and a read node identity of a blockchain node. The write node is a blockchain node having a write authority on the blockchain, the read node is a blockchain node having a read authority on the blockchain, and the write node may be called an administrator node. FIG. 2B is a schematic diagram of a data format of authority data according to an embodiment of the present disclosure. With reference to FIG. 2B, the key field indicates the chain identifier of the blockchain, the value field indicates the authority information of the blockchain, the admin field is the administrator of the blockchain, who has a write authority on the blockchain and may perform write operations, and the identity list includes nodes having a read authority on the blockchain and may read data on the blockchain. Specifically, the write node of a hello chain is a blockchain node A, and the read node includes a blockchain node B and a blockchain node F.

The second party blockchain node in the consortium blockchain network may initiate an authority update request. The authority update request may include a to-be-updated target blockchain and authority update data of the target blockchain. The second party blockchain node sends the authority update request to its own authority proxy service, that is, the second party blockchain node sends the authority update request to the second party authority proxy service. The second party authority proxy service determines whether the second party blockchain node has a write authority on the target blockchain according to the authority control data of the target blockchain, that is, the second party authority proxy service determines whether the second party blockchain node is an administrator node of the target blockchain; if the second party blockchain node is an administrator node of the target blockchain, the second party blockchain node has a write authority and may control the block production node of the authority control blockchain to write the authority update data of the target blockchain into the authority control blockchain to update the authority control data of the target blockchain. The target blockchain may be any blockchain having an authority update requirement in the consortium blockchain network.

In a case where the second party blockchain node has the write authority, the second party authority proxy service may send the authority update request to the block production node of the authority control blockchain, and the block production node writes the authority update data of the target blockchain into the authority control blockchain. It is to be noted that the block production node of the authority control blockchain is determined according to the configuration information of the authority control blockchain during the construction process and may be any node in the consortium blockchain network. If the second party blockchain node is not the administrator node of the target blockchain, the second party blockchain node has no write authority and filters the authority update request to refuse the second party blockchain node to update the authority control data of the target blockchain.

It is also to be noted that the authority proxy service associated with the block production node of the authority control blockchain may also verify the write authority of the target blockchain for the second party blockchain node. Specifically, the second party authority proxy service may send an authority update request which is not subjected to authority verification to the block production node, and the block production node determines whether the second party blockchain node has a write authority on the target blockchain; if the second party blockchain node has a write authority, the second party blockchain node executes the authority update request; and if the second party blockchain node has no write authority, the second party blockchain node refuses the authority update request. Any blockchain node in the consortium blockchain network may be used as the second party blockchain node, that is, any blockchain node may initiate an authority update request and update the authority control data of the blockchain associated with the blockchain node.

Through write authority verification, the data security of the authority control blockchain can be improved. In addition, the authority control data of the target blockchain in the authority control blockchain is updated for the blockchain node having a write authority of the target blockchain so that the authority control data of the target blockchain can be updated, thereby improving the flexibility of the blockchain authority control. For example, in the t time period, the blockchain node F does not belong to the read node of the second party blockchain, so the blockchain node F has no read authority on the second party blockchain in the t time period. However, in the t+1 time period, the blockchain node F is taken as the new read node of the second party blockchain through the authority update request for the second party blockchain, and after the blockchain node F is taken as the new read node, the blockchain node F may read the data in the second party blockchain.

In an optional embodiment, the authority update request calls authority control smart contract initiation of the target blockchain, and the authority control smart contract is constructed according to authority configuration information of the target blockchain.

In this embodiment of the present disclosure, the authority information of the blockchain may be updated through the smart contract, each target blockchain in the consortium blockchain may have its own authority control smart contract, and the authority control smart contract of the target blockchain may be constructed according to the authority configuration information of the target blockchain. In the process of constructing the target blockchain, the authority configuration information of the target blockchain may be determined, and the authority control smart contract of the target blockchain may be constructed according to the authority configuration information of the target blockchain; in a case where the authority information of the target blockchain needs to be updated, the authority control smart contract of the target blockchain may be called to initiate an authority update request for the target blockchain. The authority configuration information of the target blockchain may be set according to the personalized configuration requirements of the participants to which the target blockchain belongs, that is, the authority configuration information of the target blockchain may be a personalized authority control rule. Moreover, the blockchain may be added to the consortium blockchain network only by performing authority information configuration on the started blockchain. The authority control smart contract of the target blockchain is constructed according to the authority configuration information of the target blockchain so that the flexibility of authority control of the target blockchain can be improved.

Through the technical solution of this embodiment of the present disclosure, the authority control smart contract of the target blockchain may be called to update the authority control data of the target blockchain so that the authority control smart contract may be flexibly configured, thereby improving the flexibility of the blockchain authority control.

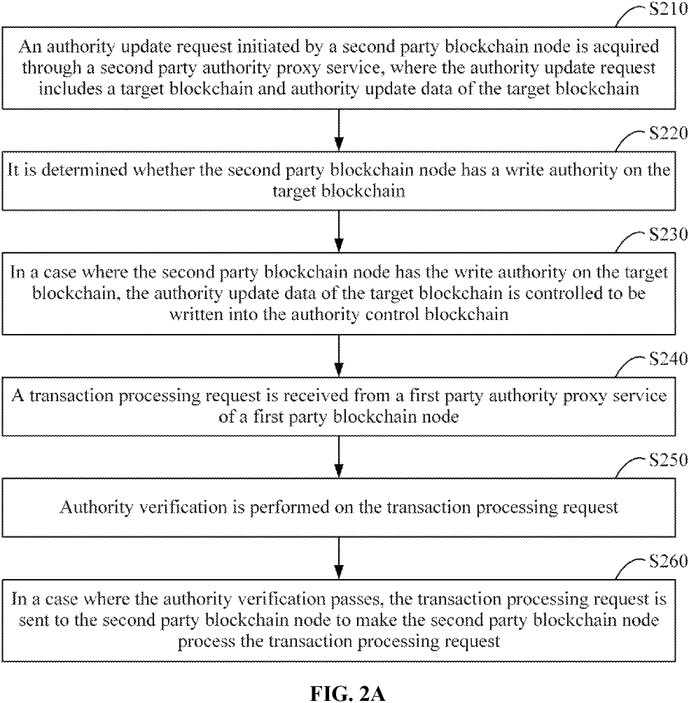

FIG. 3 is a schematic diagram of another request processing method based on a consortium blockchain according to an embodiment of the present disclosure. This embodiment is an optional solution provided on the basis of the above embodiments. With reference to FIG. 3, the request processing method based on a consortium blockchain provided by this embodiment includes steps S310, S320, and S330.

In S310, a transaction processing request is received from a first party authority proxy service of a first party blockchain node through a second party authority proxy service of a second party blockchain node.

The transaction processing request is a data query request of the first party blockchain node to a second party blockchain associated with the second party blockchain node.

In S320, it is determined whether the first party blockchain node has a read authority on the second party blockchain; if the first party blockchain node has the read authority on the second party blockchain, it is determined that the authority verification passes; and if the first party blockchain node has no read authority on the second party blockchain, it is determined that the authority verification fails.

In S330, in a case where the authority verification passes, the transaction processing request is sent to the second party blockchain node to make the second party blockchain node process the transaction processing request.

A consortium blockchain network to which the second party blockchain node and the first party blockchain node belong further includes an authority control blockchain for recording authority control data of a blockchain in the consortium blockchain network. In a case where the authority verification fails, the second party authority proxy service also shields the data query request.

In a case where the first party blockchain node has a query requirement for the second party blockchain, the first party blockchain node may initiate a data query request for the second party blockchain, the first party blockchain node sends the data query request to the second party authority proxy service through the first party authority proxy service, and the second party authority proxy service determines whether the first party blockchain node has a read authority on the second party blockchain; if the first party blockchain node has a read authority, the authority verification passes, the second party authority proxy service may send the data query request to the second party blockchain node, and the second party blockchain node executes the data query request to obtain a query result and feeds back the query result to the first party blockchain node; and if the first party blockchain node has no read authority, the authority verification fails, and the second party authority proxy service shields the data query request. The authority verification is performed through the second party authority proxy service and authentication is not performed through the second party blockchain node so that the flexibility and convenience of authority management can be improved.

In an optional embodiment, the method further includes the following step: the second second party authority proxy service monitors authority update data of the second party blockchain in the authority control blockchain, and updates authority cache data of the second party blockchain node according to the authority update data of the second party blockchain, where the second party blockchain node is associated with the second party blockchain.

The authority control blockchain also supports data monitoring, and the authority control blockchain may perform event monitoring and may also perform client SDK read interface access. The second party authority proxy service may also monitor the authority control blockchain, and in a case where second party authority proxy service monitors the authority update data of the second party blockchain, the second party authority proxy service may also update the authority cache data of the second party blockchain node according to the authority update data of the second party blockchain. The second party blockchain node may be any blockchain node in the consortium blockchain network, that is, any blockchain node in the consortium blockchain network also maintains the authority cache data of the blockchain associated with the blockchain node. Whether the authority data of the blockchain associated with the authority control blockchain in the authority control blockchain is updated is monitored, and in a case where the authority control blockchain is updated, the authority cache data of the blockchain node is updated. For example, the second party authority proxy service may synchronously update the read node identity list of the second party blockchain in real time and may also update the list of blockchains having a read authority of the second party blockchain in real time. The authority cache data of the second party blockchain node is updated in real time so that the second party authority proxy service may use its own authority cache data to perform authority verification on the transaction processing request, which can improve authority verification efficiency compared with the manner of using the authority control data in the authority control blockchain to perform authority verification on the transaction processing request, thereby improving the processing efficiency of the transaction processing request. It is to be noted that all blockchain nodes in the consortium blockchain network may maintain their own authority cache data and may perform authentication using their own authority cache data.

In addition, it is to be noted that the consortium blockchain network needs to meet the following principles: a. supporting the function of parallel chains, that is, read and write authorities of a parallel chain need to be opened and the parallel chain is used as the authority control blockchain; b. supporting data monitoring, that is, the blockchain node may monitor the authority update data of the blockchain associated with the blockchain node in the authority control blockchain; and c. supporting the account model, that is, blockchain nodes may be distinguished and named using the addresses of blockchain nodes. That is, based on the above principles, the started blockchain may be introduced into the consortium blockchain network. Developers may assemble their own consortium blockchain system by using various existing blockchains that meet constraints and performing less development configuration such as building authority control smart contracts of blockchains.

In an optional embodiment, the transaction processing request is a data query request of the first party blockchain node to the second party blockchain associated with the second party blockchain node, and the step where authority verification is performed on the transaction processing request includes: whether the first party blockchain node has a read authority on the second party blockchain is determined; if the first party blockchain node has the read authority on the second party blockchain, it is determined that the authority verification passes; and if the first party blockchain node has no read authority on the second party blockchain, it is determined that the authority verification fails.

The first party blockchain node may be the block production node of the first party blockchain, and the second party blockchain node is another blockchain node in the consortium blockchain network except the first party blockchain node. In a case where the first party blockchain node generates a new block of the first party blockchain, the first party authority proxy service may send a block synchronization request of the new block to the second party authority proxy service of the second party blockchain node, and the second party authority proxy service may determine whether the second party blockchain node has a read authority on the first party blockchain according to the authority control data of the first party blockchain. The second party authority proxy service sends the transaction processing request to the second party blockchain node only in a case where the authority verification passes, and the second party blockchain node synchronizes the new block of the first party blockchain. In addition, the second party authority proxy service may also perform authority verification according to the authority cache data of the second party blockchain node. The authority verification is performed through the second party authority proxy service and authentication is not performed through the second party blockchain node so that the flexibility and convenience of authority management can be improved.

According to the technical solution of this embodiment of the present disclosure, authentication is performed on the data query request, the block synchronization request and the like through the authority agent service which is loosely coupled with the blockchain service, thereby improving the flexibility of authority control in the consortium blockchain network. Moreover, the blockchain node synchronously updates the authority cache data of its own blockchain, thereby improving the authority verification efficiency of the blockchain node.

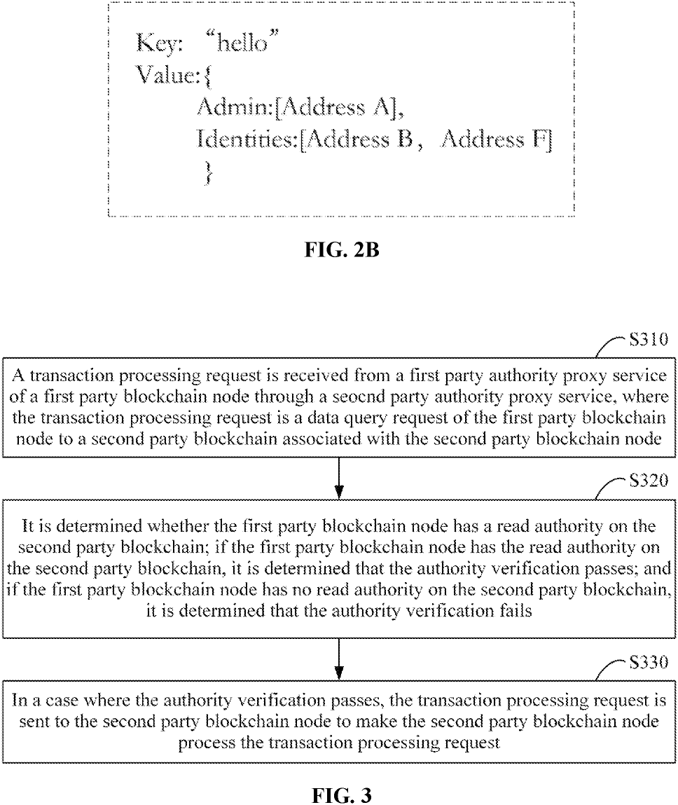

FIG. 4 is a schematic diagram of a request processing apparatus based on a consortium blockchain according to an embodiment of the present disclosure. This embodiment of the present disclosure is suitable for the case where authority control is performed on a transaction processing request of a blockchain of the consortium blockchain network. The apparatus is configured in an electronic device and may implement the request processing method based on a consortium blockchain described in any of embodiments of the present disclosure. With reference to FIG. 4, the request processing apparatus 400 based on a consortium blockchain specifically includes a request receiving module 410, a request verification module 420, and a request sending module 430.

The request receiving module 410 is configured to receive a transaction processing request from a first party authority proxy service of a first party blockchain node through a second party authority proxy service of a second party blockchain node.

The request verification module 420 is configured to perform authority verification on the transaction processing request.

The request sending module 430 is configured to, in a case where the authority verification passes, send the transaction processing request to the second party blockchain node to make the second party blockchain node process the transaction processing request.

In an optional embodiment, a consortium blockchain network to which the second party blockchain node and the first party blockchain node belong further includes an authority control blockchain for recording authority control data of a blockchain in the consortium blockchain network.

In an optional embodiment, the request processing apparatus 400 based on a consortium blockchain further includes an authority update module. The authority update module includes an update request receiving unit, a write authority verification unit, and an authority update unit.

The update request receiving unit is configured to acquire an authority update request initiated by the second party blockchain node through the second party authority proxy service; where the authority update request includes a target blockchain and authority update data of the target blockchain.

The write authority verification unit is configured to determine whether the second party blockchain node has a write authority on the target blockchain.

The authority update unit is configured to, in a case where the second party blockchain node has the write authority on the target blockchain, control the authority update data of the target blockchain to be written into the authority control blockchain.

In an optional embodiment, the authority update request calls authority control smart contract initiation of the target blockchain.

The authority control smart contract is constructed according to authority configuration information of the target blockchain.

In an optional embodiment, the transaction processing request is a block synchronization request of the first party blockchain associated with the first party blockchain node.

The request verification module 420 is configured to: determine whether the second party blockchain node has a read authority on the first party blockchain; if the second party blockchain node has the read authority on the first party blockchain, determine that the authority verification passes; and if the second party blockchain node has no read authority on the first party blockchain, determine that the authority verification fails.

In an optional embodiment, the transaction processing request is a data query request of the first party blockchain node to the second party blockchain associated with the second party blockchain node.

The request verification module 420 is configured to: determine whether the first party blockchain node has a read authority on the second party blockchain; if the first party blockchain node has the read authority on the second party blockchain, determine that the authority verification passes; and if the first party blockchain node has no read authority on the second party blockchain, determine that the authority verification fails.

In an optional embodiment, the request processing apparatus 400 based on a consortium blockchain further includes an authority cache module.

The authority cache module is configured to monitor authority update data of the second party blockchain in the authority control blockchain through the second party authority proxy service, and update authority cache data of the second party blockchain node according to the authority update data of the second party blockchain.

In the technical solution of this embodiment of the present disclosure, the blockchain service and the authority proxy service are loosely coupled, the two processes are independent of each other, the authority control is performed on the blockchain service through the independent authority proxy service, and different blockchain nodes may share an authority control strategy, that is, the authority proxy service may be reused, thereby improving the flexibility of authority control. In addition, the authority control service can be plugged and unplugged flexibly, and the consortium blockchain network may be constructed directly using the code base of the blockchain service, thereby lowering the threshold of consortium blockchain construction.

In the technical solutions of the present disclosure, acquisition, storage and application of user personal information involved herein are in compliance with relevant laws and regulations and do not violate the public order and good customs.

According to an embodiment of the present disclosure, the present disclosure further provides an electronic device, a readable storage medium and a computer program product.

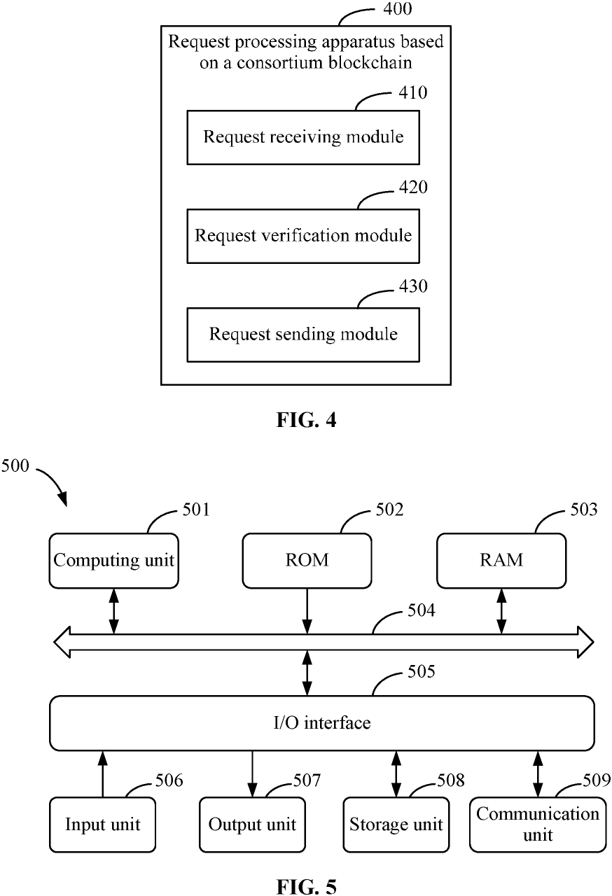

FIG. 5 is a block diagram of an example electronic device 500 for implementing the embodiments of the present disclosure. The electronic device is intended to represent various forms of digital computer, for example, a laptop computer, a desktop computer, a worktable, a personal digital assistant, a server, a blade server, a mainframe computer or another applicable computer. The electronic device may also represent various forms of mobile device, for example, a personal digital assistant, a cellphone, a smartphone, a wearable device or another similar computing device. Herein the shown components, the connections and relationships between these components, and the functions of these components are illustrative only and are not intended to limit the implementation of the present disclosure as described and/or claimed herein.

As shown in FIG. 5, the device 500 includes a computing unit 501. The computing unit 601 may perform various types of appropriate operations and processing based on a computer program stored in a read-only memory (ROM) 502 or a computer program loaded from a storage unit 508 to a random-access memory (RAM) 503. Various programs and data required for operations of the device 500 may also be stored in the RAM 503. The computing unit 501, the ROM 502 and the RAM 503 are connected to each other via a bus 504. An input/output (I/O) interface 505 is also connected to the bus 504.

Multiple components in the device 500 are connected to the I/O interface 505. The multiple components include an input unit 506 such as a keyboard and a mouse, an output unit 507 such as various types of displays and speakers, the storage unit 508 such as a magnetic disk and an optical disk, and a communication unit 509 such as a network card, a modem and a wireless communication transceiver. The communication unit 509 allows the device 500 to exchange information/data with other devices over a computer network such as the Internet and/or various telecommunications networks.

The computing unit 501 may be various general-purpose and/or special-purpose processing components having processing and computing capabilities. Some examples of the computing unit 501 include, but are not limited to, central processing units (CPUs), graphics processing units (GPUs), various special-purpose artificial intelligence (AI) computing chips, various computing units running machine learning models and algorithms, digital signal processors (DSPs), and any suitable processors, controllers and microcontrollers. The computing unit 501 performs various methods and processing described above, such as the request processing method based on a consortium blockchain. For example, in some embodiments, the request processing method based on a consortium blockchain may be implemented as a computer software program tangibly contained in a machine-readable medium such as the storage unit 508. In some embodiments, part or all of a computer program may be loaded and/or installed on the device 500 via the ROM 502 and/or the communication unit 509. When the computer program is loaded to the RAM 503 and executed by the computing unit 501, one or more steps of the preceding request processing method based on a consortium blockchain may be executed. Alternatively, in other embodiments, the computing unit 501 may be configured, in any other suitable manner (for example, by means of firmware), to perform the request processing method based on a consortium blockchain.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on a chip (SoCs), complex programmable logic devices (CPLDs), computer hardware, firmware, software and/or combinations thereof. The embodiments may include implementations in one or more computer programs. The one or more computer programs are executable, interpretable, or executable and interpretable on a programmable system including at least one programmable processor. The programmable processor may be a dedicated or general-purpose programmable processor for receiving data and instructions from a memory system, at least one input device and at least one output device and transmitting the data and instructions to the memory system, the at least one input device and the at least one output device.

Program codes for implementing the methods of the present disclosure may be compiled in any combination of one or more programming languages. These program codes may be provided for a processor or controller of a general-purpose computer, a special-purpose computer or another programmable data processing device such that the program codes, when executed by the processor or controller, cause functions/operations specified in the flowcharts and/or block diagrams to be implemented. The program codes may be executed in whole on a machine, executed in part on a machine, executed, as a stand-alone software package, in part on a machine and in part on a remote machine, or executed in whole on a remote machine or a server.

In the context of the present disclosure, the machine-readable medium may be a tangible medium that may include or store a program that is used by or used in conjunction with a system, apparatus or device that executes instructions. The machine-readable medium may be a machine-readable signal medium or a machine-readable storage medium. The machine-readable medium may include, but are not limited to, electronic, magnetic, optical, electromagnetic, infrared or semiconductor systems, apparatuses or devices or any suitable combinations thereof. More specific examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disk read-only memory (CD-ROM), an optical memory device, a magnetic memory device or any suitable combination thereof.

In order to provide the interaction with a user, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user can provide input to the computer. Other types of devices may also be used for providing interaction with a user. For example, feedback provided for the user can be sensory feedback in any form (for example, visual feedback, auditory feedback or haptic feedback). Moreover, input from the user can be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the client and the server arises by virtue of computer programs running on respective computers and having a client-server relationship to each other. The server can be a cloud server, also known as cloud computing server or cloud host, which is a host product in the cloud computing service system, so as to solve the defects of difficult management and weak business scalability in conventional physical hosts and VPS services.

It is to be understood that various forms of the preceding flows may be used, with steps reordered, added or removed. For example, the steps described in the present disclosure may be executed in parallel, in sequence or in a different order as long as the desired results of the technical solutions disclosed in the present disclosure are achieved. The execution sequence of these steps is not limited herein.

The scope of the present disclosure is not limited to the preceding embodiments. It is to be understood by those skilled in the art that various modifications, combinations, subcombinations and substitutions may be made depending on design requirements and other factors. Any modifications, equivalent substitutions, improvements and the like made within the spirit and principle of the present disclosure is within the scope of the present disclosure.

1. A request processing method based on a consortium blockchain, comprising:
receiving, through a second party authority proxy service of a second party blockchain node, a transaction processing request from a first party authority proxy service of a first party blockchain node, wherein the transaction processing request is a block synchronization request or a data query request;
performing authority verification on the transaction processing request by using authority control data of a blockchain recorded by a authority control blockchain in a consortium blockchain network, wherein the authority control data comprises a write node identity of a blockchain node which is used for updating the authority control data of the blockchain and a read node identity of a blockchain node which has a read authority on the blockchain; and
in a case where the authority verification passes, sending the transaction processing request to the second party blockchain node to make the second party blockchain node process the transaction processing request; and
in a case where the authority verification fails, refusing to forward the transaction processing request to the second party blockchain node.

2. The method according to claim 1, further comprising:
acquiring, through the second party authority proxy service, an authority update request initiated by the second party blockchain node; wherein the authority update request comprises a target blockchain and authority update data of the target blockchain;
determining whether the second party blockchain node has a write authority on the target blockchain; and
in a case where the second party blockchain node has the write authority on the target blockchain, controlling the authority update data of the target blockchain to be written into the authority control blockchain.

3. The method according to claim 2, wherein,
the authority update request calls authority control smart contract initiation of the target blockchain; and
the authority control smart contract is constructed according to authority configuration information of the target blockchain.

4. The method according to claim 1, wherein the transaction processing request is a block synchronization request of a first party blockchain associated with the first party blockchain node; and
wherein the performing authority verification on the transaction processing request comprises:
determining whether the second party blockchain node has a read authority on the first party blockchain;
in a case where the second party blockchain node has the read authority on the first party blockchain, determining that the authority verification passes; and
in a case where the second party blockchain node has no read authority on the first party blockchain, determining that the authority verification fails.

5. The method according to claim 1, wherein the transaction processing request is a data query request of the first party blockchain node to a second party blockchain associated with the second party blockchain node; and
wherein the performing authority verification on the transaction processing request comprises:
determining whether the first party blockchain node has a read authority on the second party blockchain;
in a case where the first party blockchain node has the read authority on the second party blockchain, determining that the authority verification passes; and
in a case where the first party blockchain node has no read authority on the second party blockchain, determining that the authority verification fails.

6. The method according to claim 5, further comprising:
monitoring, through the second party authority proxy service, authority update data of the second party blockchain in the authority control blockchain, and updating authority cache data of the second party blockchain node according to the authority update data of the second party blockchain.

7. A request processing apparatus based on a consortium blockchain , comprising:
at least one processor; and
a memory which is in a communication connection with the at least one processor;
wherein the memory stores an instruction executable by the at least one processor, and the instruction, when executed by the at least one processor, enables the at least one processor to perform:
receiving, through a second party authority proxy service of a second party blockchain node, a transaction processing request from a first party authority proxy service of a first party blockchain node, wherein the transaction processing request is a block synchronization request or a data query request;
performing authority verification on the transaction processing request by using authority control data of a blockchain recorded by a authority control blockchain in a consortium blockchain network, wherein the authority control data comprises a write node identity of a blockchain node which is used for updating the authority control data of the blockchain and a read node identity of a blockchain node which has a read authority on the blockchain; and
in a case where the authority verification passes, sending the transaction processing request to the second party blockchain node to make the second party blockchain node process the transaction processing request; and
in a case where the authority verification fails, refusing to forward the transaction processing request to the second party blockchain node.

8. The request processing apparatus based on a consortium blockchain according to claim 7, wherein the at least one processor is further configured to:
acquire an authority update request initiated by the second party blockchain node; wherein the authority update request comprises a target blockchain and authority update data of the target blockchain;
determine whether the second party blockchain node has a write authority on the target blockchain; and
in a case where the second party blockchain node has the write authority on the target blockchain, control the authority update data of the target blockchain to be written into the authority control blockchain.

9. The request processing apparatus based on a consortium blockchain according to claim 8, wherein,
the authority update request calls authority control smart contract initiation of the target blockchain; and
the authority control smart contract is constructed according to authority configuration information of the target blockchain.

10. The request processing apparatus based on a consortium blockchain according to claim 7, wherein the transaction processing request is a block synchronization request of a first party blockchain associated with the first party blockchain node; and
wherein the at least one processor performs authority verification on the transaction processing request by:
determining whether the second party blockchain node has a read authority on the first party blockchain;
in a case where the second party blockchain node has the read authority on the first party blockchain, determining that the authority verification passes; and
in a case where the second party blockchain node has no read authority on the first party blockchain, determining that the authority verification fails.

11. The request processing apparatus based on a consortium blockchain according to claim 7, wherein the transaction processing request is a data query request of the first party blockchain node to a second party blockchain associated with the second party blockchain node; and
wherein the at least one processor performs authority verification on the transaction processing request by:
determining whether the first party blockchain node has a read authority on the second party blockchain;
in a case where the first party blockchain node has the read authority on the second party blockchain, determining that the authority verification passes; and
in a case where the first party blockchain node has no read authority on the second party blockchain, determining that the authority verification fails.

12. The request processing apparatus based on a consortium blockchain according to claim 11, wherein the at least one processor is further configured to:
monitor authority update data of the second party blockchain in the authority control blockchain, and update authority cache data of the second party blockchain node according to the authority update data of the second party blockchain.

13. A non-transitory computer-readable storage medium storing a computer instruction, wherein the computer instruction is used for enabling a computer to perform:
receiving, through a second party authority proxy service of a second party blockchain node, a transaction processing request from a first party authority proxy service of a first party blockchain node, wherein the transaction processing request is a block synchronization request or a data query request;
performing authority verification on the transaction processing request by using authority control data of a blockchain recorded by a authority control blockchain in a consortium blockchain network, wherein the authority control data comprises a write node identity of a blockchain node which is used for updating the authority control data of the blockchain and a read node identity of a blockchain node which has a read authority on the blockchain; and
in a case where the authority verification passes, sending the transaction processing request to the second party blockchain node to make the second party blockchain node process the transaction processing request; and
in a case where the authority verification fails, refusing to forward the transaction processing request to the second party blockchain node.

14. The non-transitory computer-readable storage medium according to claim 13, wherein the computer is further configured to:
acquire an authority update request initiated by the second party blockchain node; wherein the authority update request comprises a target blockchain and authority update data of the target blockchain;
determine whether the second party blockchain node has a write authority on the target blockchain; and
in a case where the second party blockchain node has the write authority on the target blockchain, control the authority update data of the target blockchain to be written into the authority control blockchain.

15. The non-transitory computer-readable storage medium according to claim 14, wherein,
the authority update request calls authority control smart contract initiation of the target blockchain; and
the authority control smart contract is constructed according to authority configuration information of the target blockchain.

16. The non-transitory computer-readable storage medium according to claim 13, wherein the transaction processing request is a block synchronization request of a first party blockchain associated with the first party blockchain node; and
wherein the computer performs authority verification on the transaction processing request by:
determining whether the second party blockchain node has a read authority on the first party blockchain;
in a case where the second party blockchain node has the read authority on the first party blockchain, determining that the authority verification passes; and
in a case where the second party blockchain node has no read authority on the first party blockchain, determining that the authority verification fails.

17. The non-transitory computer-readable storage medium according to claim 13, wherein the transaction processing request is a data query request of the first party blockchain node to a second party blockchain associated with the second party blockchain node; and
wherein the computer performs authority verification on the transaction processing request by:
determining whether the first party blockchain node has a read authority on the second party blockchain;
in a case where the first party blockchain node has the read authority on the second party blockchain, determining that the authority verification passes; and
in a case where the first party blockchain node has no read authority on the second party blockchain, determining that the authority verification fails.
